(19) United States
(12) Patent Application Publication
(10) Pub. No.: US 2026/0199914 A1
(43) Pub. Date: Jul. 16, 2026

(54) MULTIFUNCTIONAL WATER SPRAY GUN

(71) Applicant: ZhongShan QingYi Metal Products Enterprise CO., LTD, ZhongShan City (CN)

(72) Inventors: Kaishan Zhang, ZhongShan City (CN); Kunguang Wu, ZhongShan City (CN); Shulong Li, ZhongShan City (CN); Tang Chieh Yu, Taichung City (TW)

(21) Appl. No.: 19/019,974

(22) Filed: Jan. 14, 2025

(51) Int. Cl. B05B 1/16; B05B 9/01

(52) U.S. Cl. CPC B05B 1/1681; B05B 9/01

(57) ABSTRACT

A multifunctional water spray gun comprises a gun body and a spray head unit. The spray head unit is rotatable for selecting one of nozzles to communicate with an internal passage of the gun body for spraying water. The nozzles include a circular nozzle and a fan-shaped nozzle. The fan-shaped nozzle is driven by a dial portion to rotate for a fan-shaped spray pattern in different diffusion directions. The circular nozzle is driven by an adjusting knob to move forward and backward for adjusting a spray pattern. By optimizing the structure, the water spray gun reduces the internal space occupied and has multiple functions, making it easy to use.

### FIELD OF THE INVENTION

The present invention relates to a water spray gun, and more particularly, to a multifunctional water spray gun.

### BACKGROUND OF THE INVENTION

In general, a hand-held water spray gun can be used for garden watering, road cleaning, car washing, etc. Different application scenarios need different water pressure and spraying range. For example, garden watering requires a large spraying area, while road cleaning and car washing often require high pressure and concentrated water jets to wash away dirt. However, the existing water spray guns can be classified into water spray guns that can emit high-pressure water jets and water spray guns with a wide spraying range. When in use, it is necessary to select an appropriate water spray gun according to the specific needs, which causes inconvenience and increases the use costs.

Fan-shaped sprays have the advantages of large coverage and wide range, and are commonly used in gardening and car washing. However, many spray guns on the market can only be selectively designed with horizontal fan-shaped nozzles or vertical fan-shaped nozzles due to limited space. This make it impossible to adjust the dispersion direction of the fan-shaped sprays according to the needs of use, resulting in numerous inconveniences in use.

### SUMMARY OF THE INVENTION

The primary object of the present invention is to provide a multifunctional water spray gun. A circular nozzle and a fan-shaped nozzle are integrated into the same water spray gun. The circular nozzle is configured for adjusting a spray pattern. The fan-shaped nozzle is rotatable for changing the diffusion direction of a fan-shaped spray pattern. In use, the user can select a desired nozzle to meet use needs. There is no need to replace a water spray gun and change the nozzles repeatedly, which is convenient to use.

In order to achieve the foregoing object, the present invention provides a multifunctional water spray gun, comprising a gun body and a spray head unit. The gun body has an internal passage communicating with a front end thereof for guiding a fluid to the front end. The spray head unit is rotatably connected to the front end of the gun body and communicates with the internal passage for the fluid to be sprayed out through the spray head unit. The spray head unit includes a spray head, a partition, and a bottom disc.

The spray head has a coupling end and a water outlet end. The water outlet end has a plurality of water outlets. The spray head includes a plurality of coupling seats therein. The coupling seats correspond to the respective water outlets.

The partition has a plurality of through holes. The through holes are fitted on the corresponding coupling seats. An outer periphery of the partition is in contact with a peripheral wall of the spray head.

The bottom disc has a plurality nozzles that are equally spaced along a circumferential direction of the bottom disc. Centers of the nozzles are equidistant from a center of the bottom disc. The bottom disc is coupled to the coupling end of the spray head. The nozzles are connected to the respective coupling seats so that the partition is tightly secured in the spray head to partition an interior of the spray head into a water chamber and a sealing chamber. When the spray head and the bottom disc are rotated together for selecting one of the nozzles to communicate with the internal passage, the fluid sprays out from the corresponding water outlet of the selected nozzle.

The nozzles include a circular nozzle and a fan-shaped nozzle. The fan-shaped nozzle has an axial core. The axial core is rotatably connected to the bottom disc. A front end of the axial core is inserted into a corresponding one of the coupling seats. A dial portion extends radially around an outer periphery of the axial core. The dial portion has a blocking plate and a lever protruding from an outer edge of the blocking plate. The lever extends out of an arc-shaped groove defined in the peripheral wall of the spray head. The lever is pivotable to rotate the axial core for a fan-shaped spray pattern in different diffusion directions.

The circular nozzle includes a valve core and an adjusting knob extending out of the spray head. The valve core has a valve core passage to communicate with the internal passage. A peripheral wall of a front end of the valve core has a plurality of valve core outlets communicating with the valve core passage. The valve core is connected to the bottom disc. The front end of the valve core is inserted into a corresponding one of the coupling seats. An external thread is formed on an outer surface of the valve core. The adjusting knob is sleeved on the valve core and screwed with the external thread. The adjusting knob drives the valve core to move forward and backward in an axial direction to change a distance between the valve core outlets of the valve core and a corresponding one of the water outlets for adjusting a spray pattern.

### BRIEF DESCRIPTION OF THE DRAWINGS

FIG. 1 is a perspective view of the present invention;

FIG. 2 is an exploded view of the present invention;

FIG. 3 is a rear view of a spray head of the present invention;

FIG. 4 is a perspective view of a spray head unit of the present invention;

FIG. 5 is a partial exploded view of the spray head unit of the present invention;

FIG. 6 is a front view of an axial core of a fan-shaped nozzle of the present invention;

FIG. 7 is a front view of the spray head unit of the present invention;

FIG. 8 is a cross-sectional view taken along line A of FIG. 7;

FIG. 9 is a cross-sectional view of a circular nozzle of FIG. 8 in another use state of the present invention; and

FIG. 10 is a cross-sectional view taken along line B of FIG. 7.

### DETAILED DESCRIPTION OF THE PREFERRED EMBODIMENTS

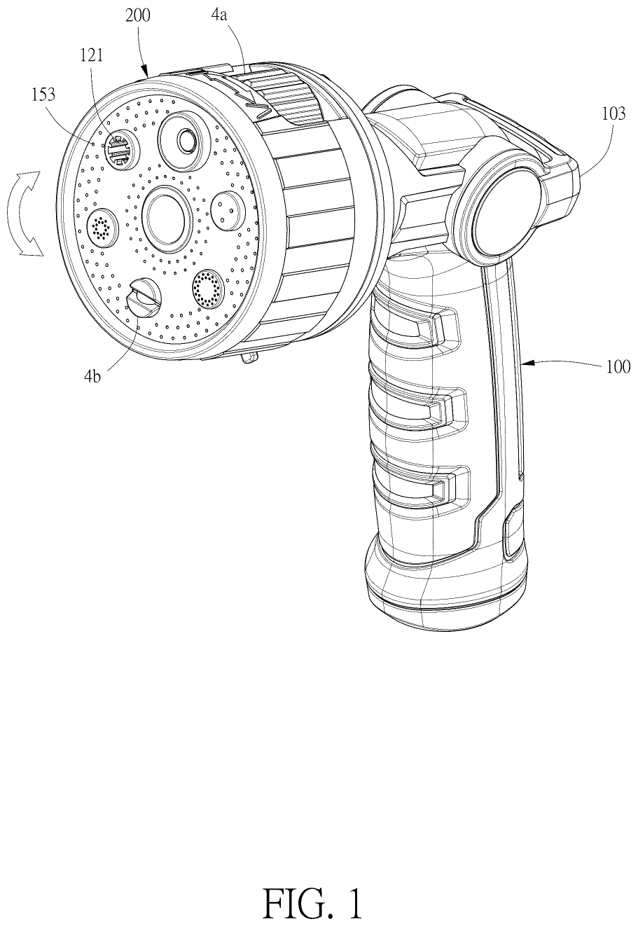

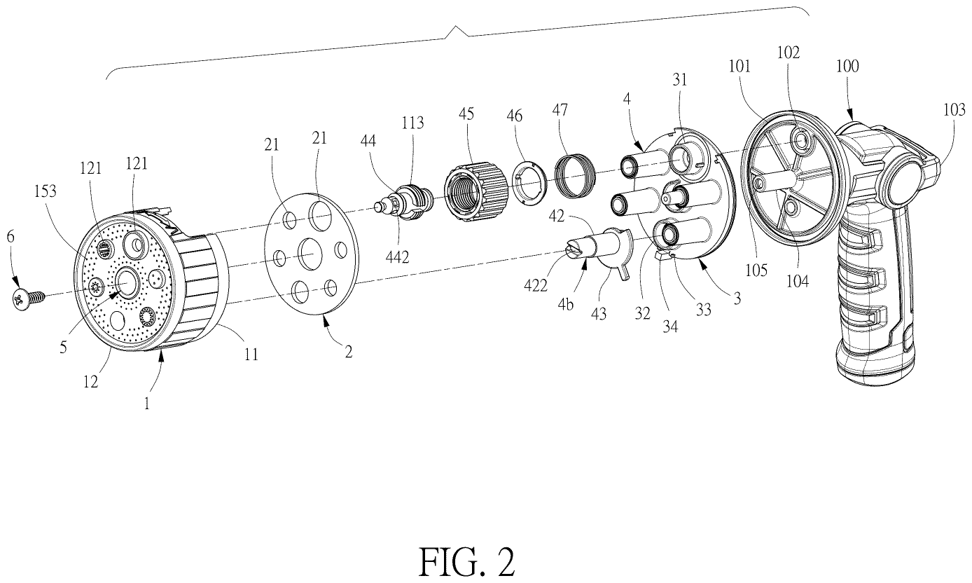

As shown in FIG. 1 and FIG. 2, the present invention discloses a multifunctional water spray gun, comprising a gun body 100 and a spray head unit 200 rotatably connected to a front end 101 of the gun body 100. The gun body 100 has an internal passage 102 communicating with the front end 101 for guiding a fluid to the front end 101. The gun body 100 includes a fluid adjustment knob 103 for adjusting the flow rate of the fluid directed to the front end 101. The spray head unit 200 communicates with the internal passage 102 for the fluid to be sprayed out through the spray head unit 200.

As shown in FIG. 2, the spray head unit 200 includes a spray head 1, a partition 2 in the spray head 1, and a bottom disc 3 equipped with a plurality of nozzles 4. A connecting post 104 extends from the front end 101 of the gun body 100. The connecting post 104 has a mounting hole 105 at a front end thereof. The spray head 1 and the bottom disc 3 each have a connecting hole 5 for insertion of the connecting post 104. A locking member 6 is inserted through the connecting holes 5 of the spray head 1 and the bottom disc 3 from one side of the spray head 1 and locked to the mounting hole 105 so that the spray head 1 and the bottom disc 3 are rotated synchronously. In this embodiment, the locking member 6 is preferably a screw to facilitate assembly and disassembly.

Further, referring to FIG. 1 through FIG. 7, the spray head 1 is preferably cylindrical and has a coupling end 11 and a water outlet end 12. The water outlet end 12 has a plurality of water outlets 121 corresponding to the nozzles 4. The spray head 1 includes a plurality of coupling seats 13 therein. The coupling seats 13 correspond to the respective water outlets 121. A raised collar 14 is provided on the inner wall of the spray head 1 close to the water outlet end 12. The partition 2 has a plurality of through holes 21. The through holes 21 of the partition 2 are fitted on the corresponding coupling seats 13. The outer periphery of the partition 2 is in contact with the inner wall of the spray head 1. One side of the partition 2, facing the water outlet end 12, rests against the raised collar 14.

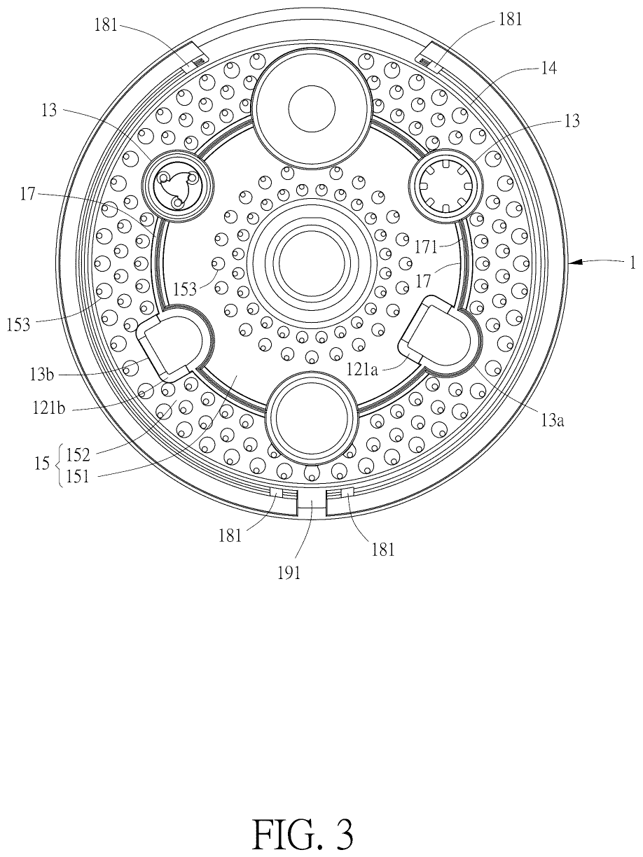

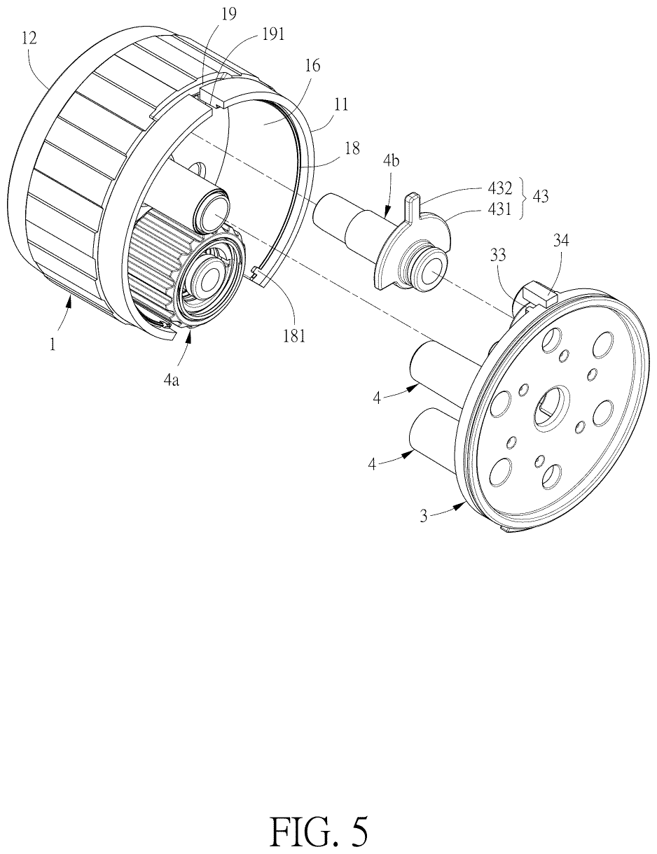

The nozzles 4 are equally spaced along the circumferential direction of the bottom disc 3. In this embodiment, preferably, six nozzles 4 are provided on the bottom disc 3. The nozzles 4 include a circular nozzle 4a and a fan-shaped nozzle 4b. In this embodiment, the fan-shaped nozzle 4b is disposed opposite the circular nozzle 4a. As shown in FIG. 2, the bottom disc 3 includes a first mounting seat 31 for mounting the circular nozzle 4a and a second mounting seat 32 for mounting the fan-shaped nozzle 4b. The other four nozzles 4 are equally spaced between the circular nozzle 4a and the fan-shaped nozzle 4b. The centers of the nozzle 4 are on the same concentric circle. The centers of the nozzles 4 are equidistant from the center of the bottom disc 3. When the nozzles 4 are coupled to the respective coupling seats 13, the partition 2 is tightly secured in the spray head 1 as shown in FIG. 3 and FIG. 5, and the interior of the spray head 1 is partitioned into a water chamber 15 and a sealing chamber 16.

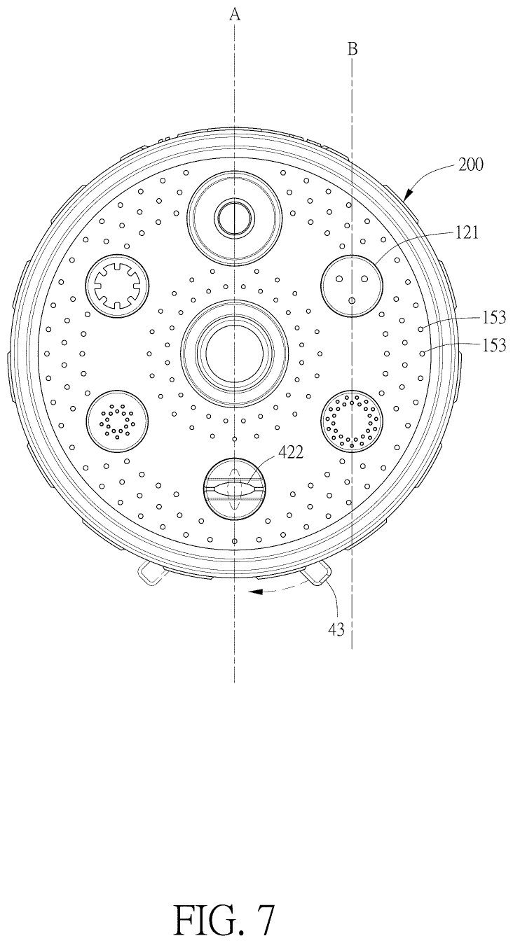

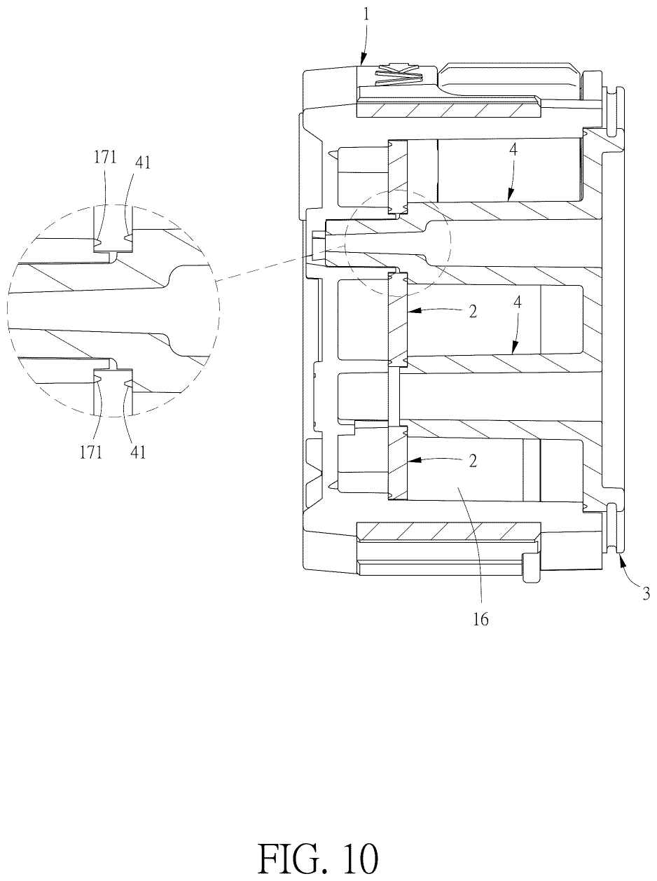

As shown in FIG. 3 and FIGS. 7 to 10, the coupling seats 13 are connected by an annular wall 17. The annular wall 17 and the partition 2 partition the water chamber 15 into an inner water chamber 151 and an outer water chamber 152. In order to enhance the sealing effect of the partition 2 on the water chamber 15 and to prevent fluid channeling between the inner water chamber 151 and the outer water chamber 152, a first toothed portion 171 is provided on the top of the annular wall 17. The first toothed portion 171 extends along the annular wall 17 and surrounds the outer periphery of each coupling seat 13. A second toothed portion 141 is provided on the top of the raised collar 14. As shown in FIG. 7, each of the nozzles 4 located between the fan-shaped nozzle 4b and the circular nozzle 4a has a third toothed portion 41 protruding from one end thereof facing the spray head 1. When the bottom disc 3 is coupled to the spray head 1, as shown in FIG. 5 to FIG. 7, the locking member 6 is inserted and locked to the connecting post 104 to exert force on the spray head 1 and the bottom disc 3, so that the ends of the nozzles 4 and the corresponding coupling seats 13 jointly press and tighten the partition 2.

Preferably, the partition 2 is made of elastic material such as rubber, silicone, thermoplastic polyurethane (TPU), soft polyvinyl chloride (PVC), and the like. The first toothed portion 171, the second toothed portion 141 and the third toothed portion 41 are pressed and embedded in the partition 2. Through the first toothed portion 171 and the third toothed portion 41 being relatively embedded in the partition 2, the partition 2 is subjected to uniform force to it is not easily deformed or displaced by the impact of the fluid, thereby preventing the fluid channeling between the inner water chamber 151 and the outer water chamber 152, sealing the junctures of the nozzles 4 and the coupling seats 13 effectively, assisting in positioning the nozzles 4, and improving the stability of the assembled structure. The second toothed portion 141 is embedded in the periphery of the partition 2 to seal the juncture of the partition 2 and the peripheral wall of the spray head 1, preventing the fluid from leaking from the water chamber 15 to the sealing chamber 16 effectively and affecting the user experience.

Furthermore, as shown in FIG. 3, both the inner water chamber 151 and the outer water chamber 152 are formed with a plurality of spray holes 153. The coupling seats 13 include a first coupling seat 13a and a second coupling seat 13b. A water outlet 121a of the first coupling seat 13a communicates with the inner water chamber 151. A water outlet 121b of the second coupling seat 13b communicates with the outer water chamber 152. When the corresponding nozzle 4 directs the fluid to the first coupling seat 13a or the second coupling seat 13b, the fluid will flow to the inner water chamber 151 or the outer water chamber 152 according to the communication of the corresponding water outlet, so that water sprays out from the spray holes 153 of the inner water chamber 151 or the outer water chamber 152. In the present invention, the water chamber is partitioned into the inner water chamber 151 and the outer water chamber 152 by the partition 2 and the annular wall 17, and the coupling seats 13 correspond in position to the water outlets 121, meeting different spraying needs without the need for additional complex structures and reducing production costs.

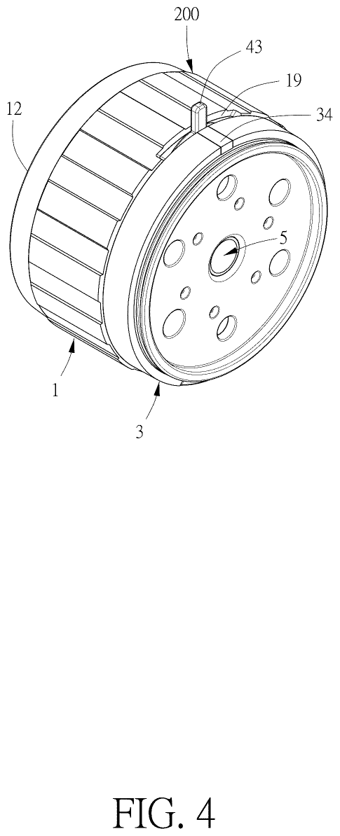

Referring to FIG. 4 and FIG. 5, a recessed collar 18 is formed on the inner edge of the coupling end 11 of the spray head 1 for mounting the bottom disc 3. One side of the bottom disc 3, facing the spray head 1, has a plurality of positioning blocks 33. The recessed collar 18 has a plurality of positioning notches 181 corresponding to the positioning blocks 33. When the bottom disc 3 is engaged with the recessed collar 18, the positioning blocks 33 are engaged in the corresponding positioning notches 181 so that the bottom disc 3 is secured to the coupling end 11 of the spray head 1, which facilitates the locking member 6 to be locked to the connecting post 104 of the gun body 100.

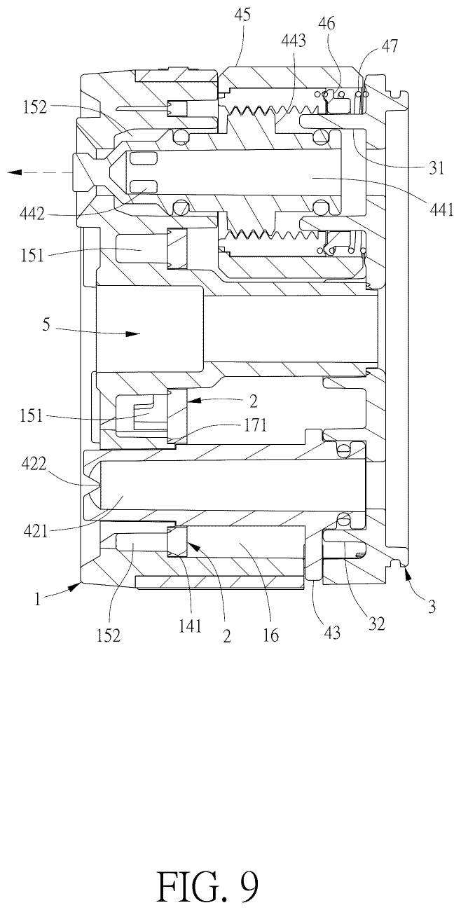

Referring to FIG. 2, FIG. 4 and FIG. 9, the fan-shaped nozzle 4b has an axial core 42. The axial core 42 has an axial core passage 421 to communicate with the internal passage 102. The front end of the axial core 42 has an axial core outlet 422 communicating with the axial core passage 421. The axial core 42 is rotatably connected to the second mounting seat 32 of the bottom disc 3. The front end of the axial core 42 is inserted into the corresponding coupling seat 13 so that the axial core outlet 422 is located at the water outlet end 12. A dial portion 43 extends radially around the outer periphery of the axial core 42. As shown in FIG. 4 and FIG. 5, the dial portion 43 extends out of an arc-shaped groove 19 defined in the peripheral wall of the spray head 1. The dial portion 43 is moved along the arc-shaped groove 19 to rotate the axial core 42. The axial core passage 421 and the second mounting seat 32 form a straight flow passage having a circular radial cross-section to ensure a straight flow of the fluid. This prevents the fluid rotating in the passage from generating a deflection force on the axial core 42, causing the axial core 42 to deviate from the original set position during use.

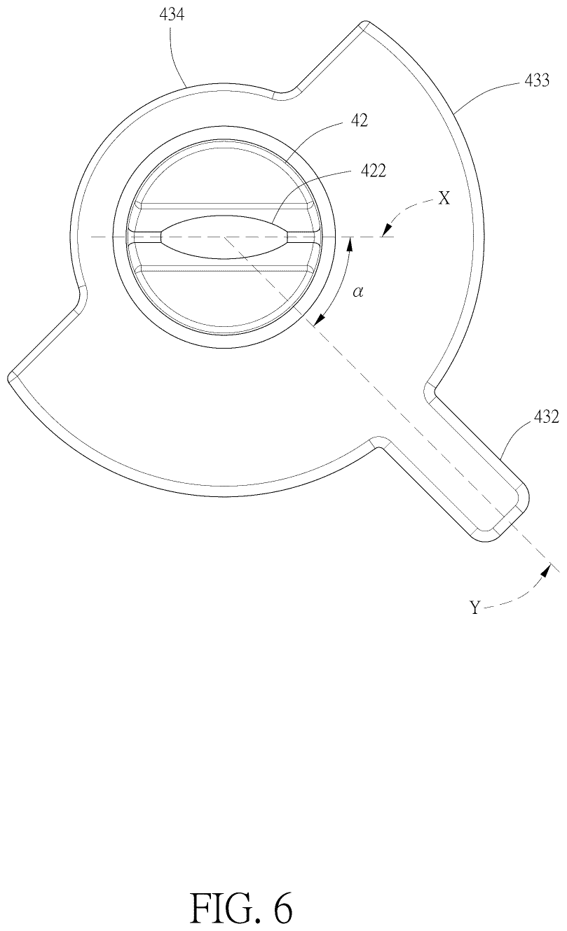

As shown in FIG. 2 and FIG. 6, preferably, the dial portion 43 is integrally formed with the outer periphery of the axial core 42. The dial portion 43 has a blocking plate 431 and a lever 432. The blocking plate 431 has a first blocking portion 433 and a second blocking portion 434. The arc radius of the first blocking portion 433 is greater than the arc radius of the second blocking portion 434. The lever 432 extends outwardly and is integrally with the outer edge of the first blocking portion 433. The first blocking portion 433 is inserted in the arc-shaped groove 19. The lever 432 extends out of the arc-shaped groove 19. The lever 432 drives the axial core 42 to rotate in the axial direction within an angle range of 0° to 90°.

Specifically, as shown in FIG. 6, the radian of the first blocking portion 433 is greater than the radian of the second blocking portion 434, so that the area of the first blocking portion 433 is greater than the area of the second blocking portion 434. The first blocking portion 433 increases the contact area between the dial portion 43 and the arc-shaped groove 19. The first blocking portion 433 is confined within the arc-shaped groove 19, thereby enhancing the overall structural stability of the dial portion 43. The blocking plate 431 cooperates with the second mounting seat 32 to restrict the axial core 42 from moving toward the bottom disc 3 when rotating, so that the axial core 42 is less likely to wobble when being rotated. The user can rotate the axial core outlet 422 to be in a horizontal position or a vertical position by pivoting the lever 432 for a horizontal fan-shaped spray pattern or vertical fan-shaped spray pattern according to the use demand. There is no need to switch nozzles, making the operation more convenient.

Furthermore, the axial core outlet 422 is in an oblong shape. The angle α at the intersection of the long axis X of the axial core outlet 422 and the central axis Y of the lever 432 is 45°. On the one hand, the angle range of rotation of the axial core 42 is reduced, which facilitates the operation of the user's finger; on the other hand, the center of the arc-shaped groove 19 is aligned with the axial core 42. When the spray head unit 200 rotates the fan-shaped nozzle 4b to communicate with the internal passage 102 of the gun body 100, the arc-shaped groove 19 is located on the top of the gun body 100, so that the lever can be pivoted with one hand for easy operation.

Referring to FIG. 4 and FIG. 5, in order to ensure that the axial core 42 is accurately aligned with the corresponding coupling seat 13 of the spray head 1 during installation, the peripheral wall of the spray head 1 has a guide groove 191. The guide groove 191 extends from the coupling end 11 toward the water outlet end 12 for the coupling end 11 to communicate with the arc-shaped groove 19. Specifically, the guide groove 191 communicates with the center of the arc-shaped groove 19 and is parallel to the corresponding coupling seat 13 of the axial core 42. During installation, when the lever 432 is moved along the guide groove 191 to the arc-shaped groove 19, the front end of the axial core 42 is aligned with the corresponding coupling seat 13 to complete the assembly, thereby improving the accuracy and efficiency of the installation. The bottom disc 3 has a guide block 34 corresponding to the guide groove 191. The guide block 34 is inserted into the guide groove 191 for guiding the bottom disc 3 to a position where it is coupled to the spray head 1, assisting the positioning blocks 33 to be aligned with and engaged in the respective positioning notches 181.

As shown in FIG. 2, the circular nozzle 4a includes a valve core 44 and an adjusting knob 45 extending out of the spray head 1. The valve core 44 has a valve core passage 441 to communicate with the internal passage 102. The peripheral wall of the front end of the valve core 44 has a plurality of valve core outlets 442 that are equally spaced and communicate with the valve core passage 441. One end of the valve core 44 is connected to the first mounting seat 31 of the bottom disc 3. The front end of the valve core 44 is inserted into the corresponding coupling seat 13. An external thread 443 is formed on the outer surface of the valve core 44. The adjusting knob 45 is sleeved on the valve core 44 and screwed with the external thread 443.

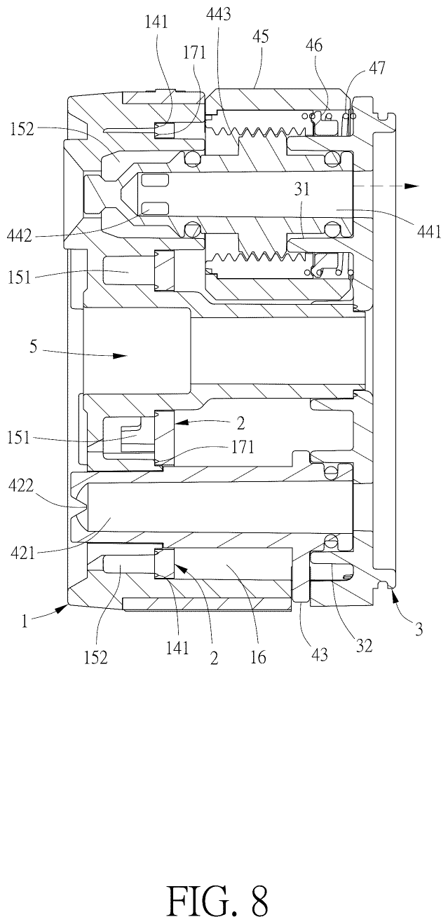

As shown in FIG. 2, FIG. 8 and FIG. 9, a damping ring 46 and an elastic member 47 are provided on one end of the adjusting knob 45, facing the bottom disc 3. The damping ring 46 and the elastic member 47 are fitted on the first mounting seat 31. One end of the elastic member 47 is against the damping ring 46, and the other end of the elastic member 47 is against the bottom disc 3. In this embodiment, the elastic member 47 is preferably a spring. The rotation of the adjusting knob 45 can drive the valve core 44 to move forward and backward in the axial direction. The damping ring 46 is pressed against the adjusting knob 45 by the elastic member 47, thereby increasing the friction during the rotation of the adjusting knob 45. When in use, the adjusting knob 45 is not easily rotated if accidentally touched, thereby positioning the valve core 44.

As shown in FIG. 8 and FIG. 9, when the valve core 44 is moved toward the bottom disc 3, the distance between the valve core outlets 442 and the water outlets 121 increases for a column-shaped spray pattern. When the valve core 44 is moved toward the water outlets 121, the distance between the valve core outlets 442 and the water outlets 121 decreases for a trumpet-shaped spray pattern. The water pressure is adjusted by changing the distance between the valve core waters 442 and the water outlets 121, which in turn changes the spray pattern.

Through the above, the multifunctional water spray gun provided by the present invention can achieve the following improvements:
Firstly, the water spray gun has multiple functions and is easy to use. In the present invention, nozzles for different spray patterns are assembled on the same spray head unit. By rotating the spray head unit to select one of the nozzles to communicate with the internal passage for different spray patterns, there is no need to replace the water spray gun to meet various needs. It is very convenient to use the water spray gun.

Secondly, the structure is optimized to take up less space inside the spray head. The fan-shaped nozzle of the present invention is rotatably arranged. The dial portion drives the fan-shaped nozzle to rotate for a horizontal fan-shaped spray pattern or vertical fan-shaped spray pattern. Compared with the traditional structure including two nozzles for fan-shaped spray patterns, the nozzles of the present invention take up less space inside the spray head. It gives users a different operating experience.

Thirdly, the structure is simple and the assembly is very accurate. In the present invention, the partition has elasticity. The locking member is locked to the connecting post to exert force on the spray head and the bottom disc, such that the first toothed portion and the second toothed portion in the spray head and the third toothed portion of the bottom disc are engaged in the partition, and the interior of the spray head is partitioned into the inner water chamber, the outer water chamber and the sealing chamber. There is no need for additional structure inside the spray head, reducing the processing difficulty of the spray head. The bottom disc has the guide block to cooperate with the guide groove of the spray head, thereby positioning the bottom disc when it is mounted to the spray head. The positioning blocks of the bottom disc are engaged in the respective positioning notches of the spray head, which assists in securing the bottom disc to the coupling end of the spray head, so as to ensure accurate alignment and to improve installation efficiency.

1. A multifunctional water spray gun, characterized in that: the multifunctional water spray gun comprises:
a gun body, having an internal passage communicating with a front end thereof for guiding a fluid to the front end; and
a spray head unit, rotatably connected to the front end of the gun body and communicating with the internal passage for the fluid to be sprayed out through the spray head unit;
wherein the spray head unit includes a spray head, a partition and a bottom disc;
wherein the spray head has a coupling end and a water outlet end, the water outlet end has a plurality of water outlets, the spray head includes a plurality of coupling seats therein, and the coupling seats correspond to the respective water outlets;
wherein the partition has a plurality of through holes, the through holes are fitted on the corresponding coupling seats, and an outer periphery of the partition is in contact with a peripheral wall of the spray head;
wherein the bottom disc has a plurality nozzles that are equally spaced along a circumferential direction of the bottom disc, centers of the nozzles are equidistant from a center of the bottom disc, the bottom disc is coupled to the coupling end of the spray head, and the nozzles are connected to the respective coupling seats so that the partition is tightly secured in the spray head to partition an interior of the spray head into a water chamber and a sealing chamber, wherein when the spray head and the bottom disc are rotated together for selecting one of the nozzles to communicate with the internal passage, the fluid sprays out from the corresponding water outlet of the selected nozzle;
wherein the nozzles include a circular nozzle and a fan-shaped nozzle; the fan-shaped nozzle has an axial core, the axial core has an axial core passage to communicate with the internal passage, a front end of the axial core has an axial core outlet communicating with the axial core passage, the axial core outlet is in an oblong shape; the axial core is rotatably connected to the bottom disc, the front end of the axial core is inserted into a corresponding one of the coupling seats, a dial portion extends radially around an outer periphery of the axial core, the dial portion has a blocking plate and a lever protruding from an outer edge of the blocking plate, the lever extends out of an arc-shaped groove defined in the peripheral wall of the spray head, and the lever is pivotable to rotate the axial core for a fan-shaped spray pattern in different diffusion directions;
wherein the circular nozzle includes a valve core and an adjusting knob extending out of the spray head, the valve core has a valve core passage to communicate with the internal passage, a peripheral wall of a front end of the valve core has a plurality of valve core outlets communicating with the valve core passage, the valve core is connected to the bottom disc, the front end of the valve core is inserted into a corresponding one of the coupling seats, an external thread is formed on an outer surface of the valve core, the adjusting knob is sleeved on the valve core and screwed with the external thread, the adjusting knob drives the valve core to move forward and backward in an axial direction to change a distance between the valve core outlets of the valve core and a corresponding one of the water outlets for adjusting a spray pattern.

2. The multifunctional water spray gun of claim 1, characterized in that the peripheral wall of the spray head further has a guide groove, the guide groove extends from the coupling end toward the water outlet end for the coupling end to communicate with the arc-shaped groove; the bottom disc has a guide block corresponding to the guide groove, the guide block is inserted into the guide groove for guiding the bottom disc to a position where the bottom disc is coupled to the spray head.

3. The multifunctional water spray gun of claim 1, characterized in that one side of the bottom disc, facing the spray head, has a plurality of positioning blocks, a recessed collar is formed on an inner edge of the coupling end of the spray head, the recessed collar has a plurality of positioning notches corresponding to the positioning blocks, the bottom disc is engaged with the recessed collar, and the positioning blocks are engaged in the corresponding positioning notches so that the bottom disc is secured to the coupling end of the spray head.

4. The multifunctional water spray gun of claim 1, characterized in that a connecting post extends from the front end of the gun body, the connecting post has a mounting hole at a front end thereof, the spray head and the bottom disc each have a connecting hole for insertion of the connecting post, a locking member is inserted through the connecting holes of the spray head and the bottom disc from the water outlet end of the spray head and locked to the mounting hole so that the spray head and the bottom disc are rotated synchronously.

5. The multifunctional water spray gun of claim 1, characterized in that the coupling seats are connected by an annular wall, the annular wall partitions the water chamber into an inner water chamber and an outer water chamber, the coupling seats include a first coupling seat having a corresponding water outlet to communicate with the inner water chamber and a second coupling seat having a corresponding water outlet to communicate with the outer water chamber, the inner water chamber and the outer water chamber are each formed with a plurality of spray holes, when the spray head unit is rotated for one of the nozzles to communicate with the internal passage, the fluid sprays out via the spray holes of the inner water chamber or the outer water chamber.

6. The multifunctional water spray gun of claim 5, characterized in that a first toothed portion is provided on a top of the annular wall, the first toothed portion extends along the annular wall and surrounds an outer periphery of each of the coupling seats, a raised collar is provided on an inner wall of the spray head close to the water outlet end, a second toothed portion is provided on a top of the raised collar; each of the nozzles located between the fan-shaped nozzle and the circular nozzle has a third toothed portion protruding from one end thereof facing the spray head, when the bottom disc is coupled to the spray head, the ends of the nozzles and the corresponding coupling seats jointly tighten the partition, and the first toothed portion, the second toothed portion and the third toothed portion are embedded in the partition for securing the partition in the spray head.

7. The multifunctional water spray gun of claim 1, characterized in that the fan-shaped nozzle is disposed opposite the circular nozzle.

8. The multifunctional water spray gun of claim 1, characterized in that the bottom disc includes a first mounting seat for mounting the valve core and a second mounting seat for mounting the axial core, a damping ring and an elastic member are provided on one end of the adjusting knob, facing the bottom disc, the damping ring and the elastic member are fitted on the first mounting seat; one end of the elastic member is against the damping ring so that the damping ring is pressed against the adjusting knob, another end of the elastic member is against the bottom disc, thereby increasing resistance to rotation of the adjusting knob to prevent accidental contact; the axial core passage and the second mounting seat form a straight flow passage having a circular radial cross-section.

9. The multifunctional water spray gun of claim 1, characterized in that the dial portion is integrally formed with the outer periphery of the axial core, the blocking plate has a first blocking portion and a second blocking portion, the first blocking portion has an arc radius greater than that of the second blocking portion, the first blocking portion has a radian greater than that of the second blocking portion; the first blocking portion is inserted in the arc-shaped groove, and the lever is integrally with an outer edge of the first blocking portion.

10. The multifunctional water spray gun of claim 1, characterized in that an angle at an intersection of a long axis of the axial core outlet and a central axis of the lever is 45°, and lever drives the axial core to rotate in the axial direction within an angle range of 0° to 90°.
